(19) United States
(12) Patent Application Publication
(10) Pub. No.: US 2018/0070614 A1
(43) Pub. Date: Mar. 15, 2018

(54) FLAVORED BEVERAGES

(71) Applicant: Givaudan, S.A., Vernier (CH)

(72) Inventors: Geoff MARSHALL-HILL, Cincinnati, OH (US); Guillaume Jean Raymond BLANCHER, Wyoming, OH (US); Allison Patricia CASTO, Mason, OH (US); Stephanie Ann Sander LINCH, Lebanon, OH (US)

(21) Appl. No.: 15/267,127

(22) Filed: Sep. 15, 2016

(51) Int. Cl. A23L 2/56; A23L 2/54

(52) U.S. Cl. CPC A23L 2/56; A23V 2002/00; A23L 2/54

(57) ABSTRACT

A flavored beverage composition is provided. The flavored beverage composition includes at least one amino acid; at least one succinic compound; and at least one flavor ingredient.

### FIELD OF THE INVENTION

The present disclosure relates to flavored beverage compositions having enhanced flavor character. More particularly, the present disclosure relates to flavored beverage compositions having improved and longer lasting taste, aroma and/or mouth feel.

### BACKGROUND

There is a growing consumer demand for flavored beverages having improved organoleptic properties, such as flavor character and mouth feel. This is especially the case in the citrus category, and more particularly in the orange juice category. Concomitantly, sugar reduction programs have created new challenges in terms of mouth feel and taste perception, in that products comprising reduced sugar are perceived as flat and less palatable.

U.S. Pat. No. 4,479,974 discloses the use of amino acids in orange-flavored dry beverage mixes and reports an improvement of the organoleptic properties of beverages produced containing these amino acids. The level of amino acids in the beverage after dilution was from 0.09 to 0.8% by weight. 1-aspartic acid was found to confer a very sour after-taste; 1-arginine, an old oranges, slightly chalky after taste; gamma-amino-butyric acid, a deeper flavor and a sour after taste; 1-aspargine, a sweet taste all the way through; and 1-proline, a full sweet-sour after taste. When mixed together, 1-proline, 1-asparagine, gamma-amino-butyric acid and 1-arginine provided a more blended flavor than a control. However, the beverage disclosed comprised also more than 10% by weight of sugars and, from the organoleptic attributes disclosed, it is not apparent that the resulting taste is closer to that of natural oranges. Furthermore 1-arginine is not generally recognized as safe in food.

Attempts to improve the flavor of low sugar beverages with sweeteners generally lead to a loss of mouth feel and body, as well as to an increase of bitterness and astringency.

In WO 2011/0311702 A1, addition of pectin to a liquid beverage is claimed to improve the mouth feel and to some extent the flavor performance, however high levels of pectin are required to provide noticeable effect, which can affect the rheological properties of beverages.

So far, no satisfactory method exists that may be used to deliver longer-lasting taste, aroma and mouth feel to flavored beverages, and particularly fruit-flavored beverages.

There is therefore a need to improve the organoleptic properties of flavored beverages, and more particularly, there is a need to provide flavored beverages, and more specifically fruit-flavored beverages with improved and longer lasting sensory profile (taste, aroma and mouth feel), and more particularly still to provide these improvements even in such beverages containing low sugar levels.

### SUMMARY

Surprisingly, the applicant has found that the addition of at least one succinic compound and at least one amino acid to flavored beverages can improve the organoleptic properties of said beverages, and more particularly deliver long-lasting taste, aroma and mouth feel to said beverages.

In one embodiment, a flavored beverage composition includes a) at least one amino acid; b) at least one succinic compound, selected from succinic acid or salt of succinic acid; and c) at least one flavor ingredient.

In another embodiment, a method of preparing a flavored beverage composition includes the steps of the sequential, separate or simultaneous admixture of at least one amino acid, at least one succinic compound, at least one flavor ingredient and any other components that together comprise said flavored beverage composition.

In another embodiment, a method of improving the organoleptic properties of a flavored beverage composition, in particular improved taste, aroma and/or mouthfeel, includes the steps of the sequential, simultaneous or separate incorporation into said flavored beverage of at least one amino acid, and at least one succinic compound.

In another aspect, the invention provides the use of at least one amino acid, and at least one succinic compound in a flavored beverage composition to improve the organoleptic properties of said composition, and in particular its taste, aroma, and/or mouth feel.

In another embodiment, a flavor concentrate adapted to be diluted with an aqueous phase to form a flavored beverage composition includes a flavored beverage concentrate comprising at least one amino acid, at least one succinic compound and at least one flavor ingredient.

These and other aspects and embodiments of the invention will be further described in the following description.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure is based on the surprising discovery that a combination of at least one amino acid and at least one succinic compound, incorporated into a flavored beverage composition could improve the organoleptic properties of said flavored beverage composition. In particular, this combination of ingredients, incorporated into a flavored beverage composition was found to provide an improved and longer lasting sensory profile, as defined by the impact, basic taste, the aroma, the blending (or roundness) and the mouth feel, which could not be achieved by any other compositions known in the art.

As used herein, the term “taste” is used to describe the sensory response related to taste receptors. The quality of taste may be expressed as the interplay of descriptors. For example, “bitter”, associated with substances such as caffeine or quinine diluted in water; “sour”, associated with acids in solution; “sour after taste”, associated with a long lasting sour feeling; and “sweet”, associated with sweetening sugars and high potency sweeteners in solution. This list of descriptors is not limitative and descriptors may change depending on the nature of the flavored beverage composition.

The term “aroma” as used herein is used to describe the effect of volatile components of the flavored beverage composition that induce a sensory response associated with olfactive receptors. The quality of the aroma of the flavored beverage compositions may likewise be expressed as the interplay of descriptors.

For example, with regard to fruit flavors, the descriptor “citrus terpenes”, is associated with oxidized citrus, slightly woody, and lime-like aroma associated with lime and other citrus fruits, “cooked orange”, associated with oranges that have been subjected to heat, similar to concentrated orange juice; “estery orange”, associated of the fruity, ripe aroma of oranges; “pith orange”, associated to the sweet, woody, and ripe orange aroma of orange juice and white pith of orange peels; “pulpy”, associated with the aroma of pulp in fresh squeezed orange juice; “sweet licorice”, associated with licorice aroma and high intensity sweeteners. This list of descriptors is not limitative and descriptors may change depending on the nature of the flavored beverage.

The term “impact” as used herein is used to describe the overall intensity of the sensory response of the “taste” and “aroma” defined herein above.

The term “mouth feel” as used herein, is used to describe the effect of the flavored beverage compositions that induce a sensory response associated to trigeminal receptor, for example “salivating” and “body sweet”, and the heaviness feeling associated with the presence of caloric sweetening sugars.

The term “long-lasting” as used herein is used to describe the duration of the overall sensory profile experience described by afore mentioned taste, aroma and mouth feel descriptors after the flavored beverage composition has been swallowed.

The term “blending” or “roundness” as used herein is used to describe the melding of the individual afore mentioned taste, aroma and mouth feel descriptors such that the flavored beverage composition presents a unified overall sensory experience.

The flavored beverage compositions according to the present disclosure, showed superior overall quality, which could not be achieved by any other flavored beverage compositions known in the art.

The at least one amino acid, and the at least one succinic compound should be present in the flavored beverage composition in an organoleptically effective amount. This amount will depend upon the nature of the amino acid and succinic compound, as well as the nature of the flavored beverage composition and the effect that is desired to be achieved, and it is within the purview of the skilled person to experiment with the desired amounts.

Typical levels of said at least one amino acid will include about 0.001 to about 0.5% by weight (wt %), based on the total weight of the flavored beverage composition. Furthermore, it is understood that the amount in wt % refers to a single ingredient, or where there is present more than one amino acid, the total amount of amino acids present.

In one embodiment, the at least one amino acid is gamma amino butyric acid (GABA) and the level of GABA includes about 0.001 to about 0.05 wt %.

Typical levels of said at least one succinic compound will include about 0.001 wt % to about 0.15 wt %. Likewise, it is understood that in relation to the levels of at least one succinic compound, the amount in wt % refer to a single ingredient, or where there is present more than one succinic compound, the total amount of succinic compounds present.

Typical levels of said at least one flavor ingredient will also depend upon the nature of said at least one flavor ingredient and the effect that is desired to be achieved. Typical levels of at least one flavor ingredient will include about 0.001 wt % to about 0.04 wt %, wherein likewise, the level in wt % refers to the single flavor ingredient, or where there is more than one flavor ingredient, the total amount of flavor ingredients.

In one embodiment, amino acids are selected from gamma amino butyric acid (GABA), L-proline, and L-serine, or mixtures thereof. In one embodiment, succinic compounds are selected from sodium succinate, di-sodium succinate, succinic acid, or mixtures thereof.

In another embodiment, the at least one amino acid may be combined with at least one dicarboxylic acid in the flavored beverage composition in an organoleptically effective amount.

In another embodiment, a flavored beverage composition is a fruit-flavored beverage composition. In another embodiment, a flavored beverage composition includes:
a) from about 0.001 to about 0.5% by weight (wt %) of at least one amino acid selected from gamma amino butyric acid, L-proline, L-serine, or a mixture thereof; and
b) from about 0.001 to about 0.15 wt % of at least one succinic compound, selected from sodium succinate, di-sodium succinate, or succinic acid, or a mixture thereof; and
c) from about 0.0001 to about 0.04 wt % of at least one flavor ingredient.

In yet another embodiment, a flavored beverage composition includes:
a) from about 0.001 to about 0.05% wt % of gamma amino butyric acid, and up to 0.999 wt % of L-proline, L-serine, or a mixture thereof; and
b) from about 0.001 to about 0.15 wt % of at least one succinic compound, selected from sodium succinate, di-sodium succinate, or succinic acid, or a mixture thereof; and
c) from about 0.0001 to about 0.04 wt % of at least one flavor ingredient.

Any flavor ingredients suitable for use in flavored beverage compositions may be employed according to the present disclosure. In one example, the flavor ingredients may include at least one fruit-flavor ingredient.

Suitable fruit-flavor ingredients include but are not limited to, 1,1-diethoxyethane; 3-hydroxybutan-2-one; 1-phenylethanone; (Z)-oxacycloheptadec-10-en-2-one; benzaldehyde; Bergamot oil; 2-methylpropyl acetate; 2-methylpropyl 2-methylbutanoate; butanal; butyric acid; 2-methylpropanoic acid; 2-methyl-5-prop-1-en-2-ylcyclohex-2-en-1-ol; (2E)-3-phenylprop-2-enal; cinnamon oil leaf; (E)-3,7-dimethylocta-2,6-dienal; 3,7-dimethyloct-6-enal; 3,7-dimethyloct-6-en-1-ol; (E)-1-(2,6,6-trimethylcyclohexa-1,3-dien-1-yl)but-2-en-1-one; 6-pentyltetrahydro-2H-pyran-2-one; 5-hexyloxolan-2-one; decanal; chroman-2-one; methyl 2-(methylamino)benzoate; dimethyl sulfide; oxydibenzene; 1-methyl-4-prop-1-en-2-ylcyclohexene; 5-octyloxolan-2-one; ethyl acetate; ethyl butanoate; ethyl 2-methylpropionate; ethyl 3-phenylprop-2-enoate; ethyl decanoate; 6-ethyl-1,5,5-trimethylbicyclo[2.2.1]heptan-6-ol; ethyl formate; ethyl heptanoate; ethyl hexanoate; ethyl 3-hydroxybutanoate; ethyl 3-hydroxyhexanoate; ethyl 2-methylbutanoate; ethyl octanoate; ethyl 3-methylbutanoate; ethyl propionate; 4-ethylphenol; pent-1-en-3-one; 2-methyl-5-propan-2-ylcyclohexa-1,3-diene; 7,11-dimethyl-3-methylidenedodeca-1,6,10-triene; 2-ethyl-4-hydroxy-5-methylfuran-3-one; (E)-3,7-dimethylocta-2,6-dien-1-ol; (E)-3,7-dimethylocta-2,6-dien-1-yl acetate; grapefruit oil; hexanal; hexaoic acid; E-hex-2-enal; (Z)-hex-3-en-1-ol; (Z)-hex-3-en-1-yl acetate; (E)-4-(2,6,6-trimethyl-1-cyclohex-2-enyl)but-3-en-2-one; (E)-4-(2,6,6-trimethylcyclohex-1-en-1-yl)but-3-en-2-one; lemon oil; lemon oil terpeneless; lime oil; lime oil terpeneless; 3,7-dimethylocta-1,6-dien-3-ol; 3,7-dimethylocta-1,6-dien-3-yl acetate; 3-hydroxy-2-methyl-4H-pyran-4-one; madarin oil; 4-methyl-4-sulfanylpentan-2-one; 2-(4-methylcyclohex-3-en-1-yl)propane-2-thiol; mercapto-para-menthan-3-one; methyl acetate; methyl 2-aminobenzoate; 2-methyl-butanoic acid; methyl 3-phenylprop-2-enoate; methyl 3-oxo-2-pentylcyclopentaneacetate; 5-methylfuran-2-carbaldehyde; 7-methyl-3-methyleneocta-1,6-diene; (Z)-3,7-dimethylocta-2,6-dien-1-yl acetate; 5-pentyloxolan-2-one; nonanal; 4,4a-dimethyl-6-(prop-1-en-2-yl)-4,4a,5,6,7,8-hexahydronaphthalen-2(3H)-one; 5-butyloxolan-2-one; octanal; octanoic acid; orange cold pressed oil; orange essence oil; orange oil terpenes; orris concrete; osmanthus absolute; 2,3-pentanedione; 3-methylbutyl acetate; 3-methylbutyl 3-methylbutanoate; propyl acetate; rose oil; (2E,6E,9E)-2,6,10-trimethyldodeca-2,6,9,11-tetraenal; (2E,6E)-2,6-dimethyl-10-methylidenedodeca-2,6,11-trienal; tangerine cold pressed oil; tarragon oil; 4-methyl-1-propan-2-ylcyclohex-3-en-1-ol; 1-methyl-4-propan-2-ylcyclohexa-1,3-diene; 2-(4-methyl-1-cyclohex-3-enyl)propan-2-ol; 1-methyl-4-(propan-2-ylidene)cyclohex-1-ene; 2-(4-methylcyclohex-3-en-1-yl)propan-2-yl acetate; 4a,5-dimethyl-3-prop-1-en-2-yl-2,3,4,5,6,7-hexahydro-1H-naphthalene; 4-hydroxy-3-methoxybenzaldehyde; and mixture thereof.

Flavored beverage compositions according to the present disclosure may contain other optional ingredients. For example, flavored beverage compositions may contain a salt of citric acid. Suitable citric acid salts include potassium citrate or sodium citrate, or mixtures thereof.

When present in a flavored beverage composition, said salts of citric acid may be present in amounts of about 0.3 to 0.7 wt % based on the weight of the flavored beverage composition.

Flavored beverage composition according to the present disclosure may contain a weighting agent. Suitable weighting agents include any of those weighting agents known in the art for use in flavored beverage compositions. Examples of suitable weighting agents include, but are not limited to sucrose esters, such as saccharose acetate isobutyrate (SAIB), polyol fatty acid esters, polyol benzoates, rosin gums, ester gums, and the like.

When a weighting agent is employed in a flavored beverage composition, it may be used in amounts up to 150 wt % based on the total amount of flavor ingredients contained in the flavored beverage composition.

Other ingredients that might be employed in flavored beverage compositions include, but are not limited to fruit pulp; sweeteners; organic acids, such as malic acid, lactic acid, and the like; nutritional supplements, such as vitamins and mineral salts; antioxidants; preservatives; rheology modifiers; solvents; buffering agents; clouding agents; and dyes.

Flavored beverage compositions according to the present disclosure may contain low levels of sugar whilst maintaining the improved organoleptic properties. In one embodiment, flavored beverage compositions may contain less than 10 wt % sugar, in another embodiment about 7 wt %, and in yet another embodiment about 5 wt %.

In one embodiment the flavored beverage composition may be carbonated.

The invention will be further described with reference to methods of forming flavored beverage compositions, which methods form additional aspects of the invention.

A flavored beverage composition according to the present disclosure may be prepared when the at least one amino acid; the at least one succinic compound; the at least one flavor ingredient; and any other optional ingredients referred to hereinabove are mixed together to form the flavored beverage composition.

The manner or sequence in which the ingredients are mixed is not particularly important, although when selecting the method in which the essential or optional ingredients are combined, the skilled person will have regard to routine considerations related to supply chain, such as ease and cost of manufacture, storage, transportation and the like. In particular, the skilled person will have regard for any incompatibility that might exist between any of the ingredients, e.g., immiscibility of ingredients. For example, the flavor ingredients useful in the present invention may be water-soluble or oil-soluble, or a mixture of water-soluble and oil-soluble ingredients.

The at least one amino acid, and the at least one succinic compounds are water-soluble; whereas citric acid salts are not soluble in flavor oils.

In principle, it is possible that all ingredients may be mixed together extemporaneously to provide the flavored beverage composition of the present invention. However, for the reasons set forth immediately above, extemporaneous preparation may not be advantageous or even desirable.

More typically, however, the preparation of flavored beverage compositions according to the present disclosure proceeds by first forming a flavor concentrate comprising the at least one amino acid; the at least one succinic compound; the at least one flavor ingredient; and any of the optional ingredients as desired or appropriate. Thereafter, the flavor concentrate may be diluted with an aqueous phase, which may contain any of the other optional ingredients that are desired or appropriate, in order to provide the flavored beverage composition.

Flavor concentrates including the at least one amino acid; the at least one succinic compound; and at least one flavor ingredient; and optionally at least one citrate compound represents an additional aspect of the present disclosure.

Flavor concentrates may be in the form of emulsions, solutions or dispersions, or in powdered form. For example, it may be desirable or appropriate to add flavor ingredients that are oils, or are oil-soluble to a solution containing all water-soluble ingredients and emulsify the resultant mixture. The flavor concentrate, in the form of an emulsion could then be further diluted in an aqueous phase, as necessary or appropriate, to form the flavored beverage composition.

Alternatively, it might be desirable or appropriate to mix both oil and oil-soluble ingredients, and water-soluble ingredients with a compatible solvent or solvent system, such as propylene glycol, isopropanol, glycerol, ethanol, water, or mixtures thereof to form a flavor concentrate in the form of a solution or dispersion, which can then be further diluted in an aqueous phase as necessary or appropriate, to form the flavored beverage composition.

In yet another alternative, the at least one flavor ingredient; the at least one amino acid; the at least one succinic compound; and optionally the at least one citrate compound are rendered in dry form, and mixed to form a flavor concentrate in the form of a powder, which can then be further diluted as necessary or appropriate in an aqueous phase to for the flavored beverage composition.

The aqueous phase in which the flavor concentrate may be diluted, may consist of water, or it may contain any of the water-soluble optional ingredients referred to herein. The aqueous phase may comprise a fruit juice, a fruit juice concentrate, a fruit pulp, or a mixture thereof.

The fruit juice may be obtained by pressing fresh fruit and removing the insoluble pulp, skin and seeds.

A fruit juice concentrate is processed to remove a defined proportion of the natural water content found in the fruit and produce a concentrated product which is smaller in volume.

A fruit pulp (or puree) is a thick, smooth product, which has been processed such that the insoluble fibrous parts are broken up so as to be able to fit through a fine sieve.

In one embodiment, the flavor concentrate is provided in the form of an emulsion comprising:
i. from about 0.2 to about 8 wt % of at least one amino acid selected from gamma amino butyric acid, L-proline, L-serine, or a mixture thereof; and
ii. from about 0.2 to about 16 wt % of at least one succinic compound, selected from sodium succinate, di-sodium succinate, or succinic acid, or a mixture thereof; and
iii. from about 1 to about 11 wt % by weight of a mixture comprising from about 40 to about 100 wt % of a flavor ingredient and, optionally, from about 0 to 60 wt % of a weighting agent; and
iv. from about 0.1 to about 10 wt % of at least one emulsifier; and
v. optionally, up to about 4 wt % by weight of a rheology modifier; and
vi. optionally, up to 3 wt % of antioxidants and preservatives; and
vii. water to complete to 100% by weight emulsion.

In another embodiment, the flavor concentrate is provided in the form of an emulsion comprising:
i. from about 1 to about 8 wt % of gamma amino butyric acid; and
ii. from about 1 to about 16 wt % of at least one succinic compound, selected from sodium succinate, di-sodium succinate, or succinic acid, or a mixture thereof; and
iii. from about 1 to about 11 wt % by weight of a mixture comprising from about 40 to about 100 wt % of a flavor ingredient and, optionally, from about 0 to 60 wt % of a weighting agent; and
iv. from about 0.1 to about 10 wt % of at least one emulsifier; and
v. optionally, up to about 4 wt % by weight of a rheology modifier; and
vi. optionally, up to 3 wt % of antioxidants and preservatives; and
vii. water to complete to 100% by weight emulsion.

Flavor concentrates in the form of emulsions may be prepared by the steps of:
a. incorporating a flavor oil and optionally a weighting agent into an aqueous phase comprising an emulsifier under stirring with a paddle or an anchor mixing device to form coarse dispersion of the oil phase in the aqueous phase;
b. incorporating the at least one amino acid and the at least one succinic compound in this coarse dispersion; and
c. submitting said dispersion to high shear mixing, for example by using a high shear mixer, a disperser homogenizer, a high pressure homogenizer, or a membrane emulsifier.

Alternatively, a flavor concentrate in the form of an emulsion, may be prepared by the steps of:
a. preparing a first, concentrated, flavor oil-in-water emulsion; and
b. diluting this concentrated flavor emulsion with an aqueous phase comprising the at least one amino acid and the at least one succinic compound in order to form a flavor emulsion.

The concentrated flavor oil-in-water emulsion may comprise:
a) from about 5 to about 25 wt % by weight of a mixture comprising from about 40 to about 100 wt % of the at least one flavor ingredient and, optionally, from about 0 to 60 wt % of a weighting agent; and
b) from about 0.1 to about 20 wt % by weight of at least one emulsifiers; and
c) optionally, up to 4 wt % by weight of a rheology modifier; and
d) optionally, up to 5 wt % of antioxidants and preservatives; and
e) water to complete to 100% by weight emulsion.

The flavor concentrate in the form of an emulsion may be further diluted in water, or admixed with a fruit juice or a fruit juice concentrate, which can be further diluted in an aqueous phase comprising, optionally the at least one citrate compound to form a flavored beverage composition according to the present invention, wherein the level of the citrate compound in the aqueous phase is set in such a way that the level of the citrate compound in the flavored beverage composition is from about 0.3 to about 0.7 wt %.

Suitable emulsifiers may be selected from, but not limited to Quillaja, gum Arabic, gum Ghatti, Konjac gum, octenyl succinate-modified starch, sucrose esters, polyoxyethylene sorbitan fatty acid esters, lecithin, or mixture thereof.

Suitable rheology modifiers may be selected from, but not limited to Xanthan gum, Guar gum, Gellan gum, octenyl succinate-modified starch or mixture thereof. In one embodiment, the rheology modifier is Xanthan gum.

The flavor concentrates may also include additives, such as colorants, for example, carotenoids, anti-oxidants, for example Tocopherol, Ascorbic acid, Malic acid, Citric acid, sweeteners, nutritional supplements, such as vitamins and mineral salts, antioxidants, clouding agents, weighting agents, and dyes and the like.

The volume average emulsion droplet size Dv 50 of the flavor emulsion is from about 0.1 to about 10 micrometer, more particularly from about 0.05 to 5 micrometer.

The above range of volume average emulsion droplet size includes droplet sizes that are smaller than the wavelengths of the visible light waves. Emulsions having volume average emulsion droplet size in this range are transparent to light and are also part of the present disclosure.

As used herein, the volume average particle size is measured by light scattering measurements using a Malvern 2000S instrument and the Mie scattering theory. The principle of the Mie theory and how light scattering can be used to measure droplet size can be found, for example H. C. van de Hulst, Light scattering by small particles. Dover, N.Y., 1981. The primary information provided by static light scattering is the angular dependence of the light scattering intensity, which in turn is linked to the size and shape of the droplets. However, in a standard operation method, the size of a sphere having a size equivalent to the size of the diffracting object, whatever the shape of this object, is calculated by the Malvem proprietary software provided with the apparatus. In case of polydisperse samples, the angular dependence of the overall scattering intensity contains information about the size distribution in the sample. The output is a histogram representing the total volume of droplets belonging to a given size class as a function of the capsule size, whereas an arbitrary number of 50 size classes can be chosen.

Experimentally, a few drops of flavor emulsion are added to a circulating stream of degased water flowing through a scattering cell. The angular distribution of the scattering intensity is measured and analyzed by Malvem proprietary software to provide the average size and size-distribution of the droplets present in the sample. In the context of the present invention the percentiles Dv 10, Dv 50 and Dv 90 are used as characteristics of the droplets size distribution, whereas Dv 50 corresponds to the median of the distribution.

Flavor concentrates in the form of a powder may be prepared by the following method:
a. preparing a flavor emulsion comprising an at least one amino acid; and an at least one succinic compound and a polycarbohydrate bulking agent; and
b. spray drying or spray coating said flavor emulsion to form a powder flavor concentrate.

Thereafter, the powder flavor concentrate may be dissolved in an aqueous phase comprising the at least one citrate compound to form a flavored beverage composition.

The polycarbohydrate bulking agent may be a modified starch, for example hydrolysed starch bearing octenyl succinate groups, maltodextrins. The polycarbohydrate bulking agent may be deposited on a solid carrier material, such as crystalline or granulated sugar by means of an agglomeration process, for example in a fluidised bed. Preferably, the agglomeration is carried out in any of the well-known fluidized bed dryers equipped with a product container. The process is started with the fluidization of the core material. The flavor emulsion may thereafter be sprayed on to the fluidized core particles using a pressure, sonic or a pneumatic nozzle, preferably, a two-fluid nozzle, or a three-fluid nozzle which is inserted either on the top (top spray), lateral (lateral spray), tangential (tangential spray), or at the bottom (bottom spray) of the fluidized bed. Alternatively, the flavor emulsion may be applied to the core particles in a spray coating process, wherein the core particles size and particle size distribution are commensurate with the desired final delivery system particle size and particle size distribution. The spray coating process may be performed in a fluidized bed dryer, a drum coater, a pan coater or a Loedige mixer, or any mechanical device, where the particulate core material is put in motion in such a way that the surface of the particles is homogeneously exposed to the spray providing the atomized flavor emulsion.

In one embodiment, a flavor emulsion that is to be spray dried or spray coated to form a powder flavor concentrate comprises:
i. from about 1 to about 8 wt % of at least one amino acid selected from gamma amino butyric acid, L-proline, L-serine, or a mixture thereof; and
ii. from about 1 to about 16 wt % of at least one succinic compound, selected from sodium succinate, di-sodium succinate, or succinic acid, or a mixture thereof; and
iii. from about 10 to about 20 wt % by weight of a mixture comprising from about 40 to about 100 wt % of a flavor ingredient and, optionally, from about 0 to 60 wt % of a weighting agent; and
iv. from about 5 to about 20 wt % of octenyl succinate-modified starch; and
v. from about 5 to about 20 wt % of maltodextrin; and
vi. optionally, up to 3 wt % of antioxidants and preservatives
vii. water to complete to 100% by weight emulsion.

In another embodiment, a flavor emulsion that is to be spray dried or spray coated to form a powder flavor concentrate comprises:
i. from about 4 to about 8 wt % of at least one amino acid selected from gamma amino butyric acid, L-proline, L-serine, or a mixture thereof, and
ii. from about 2 to about 10 wt % of at least one succinic compound, selected from sodium succinate, di-sodium succinate, or succinic acid, or a mixture thereof, and
iii. from about 12 to about 16 wt % by weight of a mixture comprising from about 40 to about 100 wt % of a flavor ingredient and, optionally, from about 0 to 60 wt % of a weighting agent; and
iv. from about 7 to about 10 wt % of octenyl succinate-modified starch; and
v. from about 15 to 20 wt % of maltodextrin; and
vi. optionally, up to 3 wt % of antioxidants and preservatives
vii. water to complete to 100% by weight emulsion.

The powder flavor concentrate obtained by spray drying is a powder with a particle volume average size of from about 10 to about 100 micrometers (about 200 micrometers if a multistage spray dryer is used), as measured by light scattering, using a measuring cell that is suitable for powders, whereas the powder flavor concentrate obtained by spray coating is in granulate form with volume (or number) average size of from about 200 to 500 micrometers or more.

### EXAMPLES

The following examples are given solely for the purpose of illustration and are not to be construed as limitations of the present invention, as many variations of the invention are possible without departing from the spirit and scope of the present disclosure.

### Example 1

### Flavor Ingredient Composition:

A citrus flavor ingredient composition, used in Example 2 and 3 (formula 2.1, 2.2, 2.3, 2.4 and 2.8) is disclosed in Table 1A

TABLE 1A
Citrus flavor

| Ingredient | Weight % |
|---|---|
| Alkyl esters | 0.4 |
| Orange oil | 78.4 |
| Terpenyl alcohols | 1.2 |
| Aldehydes | 0.3 |
| Citrus oil | 2.0 |
| Sesquiterpenes | 17.5 |
| Antioxidant | 0.2 |

A mango flavor ingredient composition, used in Example 2 and 3 (formula 2.6) is disclosed in Table 1B

TABLE 1B
Mango flavor

| Ingredient | Weight % |
|---|---|
| Alkyl esters | 30 |
| Alkyl and terpenyl alcohols | 23 |
| Furanones | 10 |
| Alkyl and terpenyl sulfurs | 1 |
| Terpenes | 8 |
| Alkyl acids | 20 |
| Lactones | 8 |

A strawberry flavor ingredient composition, used in Example 2 and 3 (formula 2.7) is disclosed in Table 1C

TABLE 1C
Strawberry flavor

| Ingredient | Weight % |
|---|---|
| Alkyl esters | 35 |
| Alkyl and terpenyl alcohols | 30 |
| Furanones | 5 |
| Alkyl sulfurs | 0.2 |
| Alkyl ketones | 5 |
| Alkyl acids | 14.8 |
| Lactones | 10 |

### Example 2

### Flavored Beverage Compositions

Table 2.1 discloses typical levels of amino acid, succinic compound, flavor ingredient and optional citric acid salt in the beverage compositions.

TABLE 2.1
Example of flavored beverage compositions according to the present disclosure

| Ingredient | 2.1 | 2.2 | 2.3 | 2.4 | 2.6 | 2.7 | 2.8 |
|---|---|---|---|---|---|---|---|
| Water phase | 98.364 | 93.529 | 86.540 | 99.200 | 93.85 | 94.33 | 99.2231 |
| Flavor ingredients | 0.016 | 0.016 | 0.090 | 0.100 | 0.1 | 0.1 | 0.1 |
| Gamma amino | 0.030 | 0.020 | 0.050 | 0.015 | 0.015 | 0.015 | 0.0014 |
| butyric acid | | | | | | | |
| (ingredient a)) | | | | | | | |
| Di-sodium | 0.040 | 0.035 | 0.120 | 0.025 | 0.025 | 0.025 | 0.001 |
| succinate | | | | | | | |
| (ingredient b)) | | | | | | | |
| Malic acid | | | | 0.125 | 0.01 | 0.1 | 0.125 |
| Citric acid | 0.800 | 0.400 | 1.400 | 0.115 | | 0.36 | 0.115 |
| Potassium citrate | 0.500 | 0.300 | 0.700 | 0.320 | | 0.07 | 0.32 |
| Sugar | | 5.500 | 11.00 | | 6.000 | 5.000 | |
| Sweetener | 0.050 | | | | | | 0.0145 |
| Gellan gum | | | | | | | 0.1 |
| Minor ingredients | 0.200 | 0.200 | 0.100 | 0.100 | | | |

Table 2.2 discloses comparative examples to Table 2.1 without ingredients a) and b).

TABLE 2.2
Comparative examples

| Ingredient | 2.1b | 2.2b | 2.3b | 2.4b | 2.6b | 2.7b | 2.8b |
|---|---|---|---|---|---|---|---|
| Water phase | 98.434 | 93.584 | 86.71 | 99.34 | 93.890 | 94.37 | 99.3255 |
| Flavor ingredient | 0.016 | 0.016 | 0.09 | 0.1 | 0.1 | 0.1 | |
| Malic acid | | | | 0.125 | 0.01 | 0.1 | 0.125 |
| Citric acid | 0.8 | 0.4 | 1.4 | 0.115 | | 0.36 | 0.115 |
| Potassium citrate | 0.5 | 0.3 | 0.7 | 0.32 | | 0.07 | 0.32 |
| Sugar | | 5.5 | 11 | | 6 | 5 | |
| Sweetener | 0.05 | | | | | | 0.0145 |
| Minor ingredients | 0.2 | 0.2 | 0.1 | 0.1 | | | 0.1 |

### Example 3

### Sensory Results

The overall quality of the beverage samples has been assessed by a panel of 12 Sensory trained panelists by comparing the flavored beverage samples with amino acid and succinic compound (Table 2) and without amino acid and without succinic compound (Table 3), The results are reported in Table 3

TABLE 3

| | Beverage 1 (Representative | Beverage 2 (Reference) |
|---|---|---|
| | of Invention) | (without amino acid and |
| | (with amino acid and | without succinic compound, |
| | succinic compound, Table 2) | Table 3) |
| Formula | +++ | ++ |
| 2.8 vs. 2.8b | 2.8 found to be more long | |
| | lasting and closer to | |
| | fresh fruit | |
| Formula | ++ | +/− |
| 2.4 vs. 2.4b | 2.4 found to be more long | |
| | lasting and overall sensory | |
| | profile | |
| Formula | +++ | + |
| 2.6 vs. 2.6b | 2.6 found to have an | |
| | increased flavor impact; | |
| | improved mouthfeel and | |
| | overall sensory profile | |
| Formula | +++ | + |
| 2.7 vs. 2.7b | 2.7 found to have improved | |
| | flavor profile, impact, | |
| | mouthfeel, roundness and | |
| | long lastingness | |
| (Formula | ++ | + |
| 2.7 vs. 2.7b) | 2.7 found to have improved | |
| | flavor profile, impact, | |
| | mouthfeel, roundness and | |
| | long lastingness | |

### Example 4

### Emulsion Compositions and Process

This example illustrates the preparation of a flavor emulsion according to the present disclosure. First, a concentrated emulsion comprising the flavor ingredient composition of, Example 1, the emulsifier and water is prepared. Second, this concentrated emulsion is diluted in an aqeuous phase comprising an amino acid and di-sodium succinate.

### A. Concentrated Emulsion

In a first step, the emulsifier (octenyl succinate modified starch) (60 parts) is hydrated with and dissolved in water (703 parts) and sodium benzoate (1.7 parts) is added to the solution and dissolved under stirring to form an aqueous phase. Then, citric acid (5 parts) is added and dissolved under stirring.

In parallel, sucrose acetate isobutyrate (120 parts) and the flavor ingredient composition of Example 1 (110 parts) are mixed together in a separate vessel to form a flavor oil phase.

In a second step, the flavor oil phase is added to and pre-mixed the aqueous phase with a paddle mixer, and then dispersed with a multistage homogenizor to form the flavor emulsion having an average droplet size of less than 3 micrometers.

### B. Enrichment of the Flavor Emulsion

In a first step, the emulsifier and rheology modifier xanthan gum (3 parts) are hydrated with and dissolved in water (608 parts) and sodium benzoate (1.5 parts) is added to the solution and dissolved under stirring to form an aqueous phase. Then, citric acid (4.5 parts) is added to and dissolved in this aqueous phase under stirring.

In a second step, the amino acid (gamma amino butyric acid, 80 parts) and the succinic compound (di-sodium succinate, 140 parts) are added to the concentrated flavor emulsion and dissolved under stirring.

In a third step, the concentrated emulsion A (160 parts) and the water-soluble flavor ingredients (1.8 parts) are added to and dispersed into the aqueous phase under vigorous stirring.

### Example 5

### Spray Drying—Composition and Process

This example illustrates the preparation of a powder flavor concentrate according to the present disclosure by spray drying. The percentage of each emulsion component is in weight percent, relative to the total concentrated emulsion.

In a first step, 342 parts of a 50 wt % maltodextrin premix in deionized water is diluted with 260 parts deionized water. Starch octenyl succinate (260 parts) is then slowly added and dissolved under mixing. Ascorbic acid (1 part) amino acid (gamma amino butyric acid, ingredient a), 60 parts), and the succinic compound (di-sodium succinate, ingredient b), 40 parts), and granulated fruit sugar (69 parts) are then added and dissolved under mixing.

In a second step, the flavor oil phase (142.5 parts) is added to and dispersed into the aqueous phase with a homogenizer to form a concentrated flavor emulsion.

In third step, this concentrated flavor emulsion is spray dried using a conventional spray dryer, using a pressure nozzle operating at 130 bar, an inlet temperature of 140+/−10° C., and an outlet temperature of 60° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A flavored beverage composition comprising:
a) at least one amino acid;
b) at least one succinic compound; and
c) at least one flavor ingredient.

2. The flavored beverage composition according to claim 1, further comprising at least one citrate compound selected from sodium citrate, potassium citrate, or mixtures thereof.

3. The flavored beverage composition according to claim 1, wherein the at least one amino acid is selected from the group consisting of gamma amino butyric acid, L-proline, L-serine, and mixtures thereof.

4. The flavored beverage composition according to claim 1, wherein the at least one succinic compound is selected from the group consisting of sodium succinate, di-sodium succinate, succinic acid, and mixtures thereof.

5. The flavored beverage composition according to claim 1, wherein the at least on flavor ingredient is a fruit flavor ingredient.

6. The flavored beverage composition according to claim 5, wherein the fruit flavor ingredient is selected from the group consisting of:—1,1-diethoxyethane; 3-hydroxybutan-2-one; 1-phenylethanone; (Z)-oxacycloheptadec-10-en-2-one; benzaldehyde; Bergamot oil; 2-methylpropyl acetate; 2-methylpropyl 2-methylbutanoate; butanal; butyric acid; 2-methylpropanoic acid; 2-methyl-5-prop-1-en-2-ylcyclohex-2-en-1-ol; (2E)-3-phenylprop-2-enal; cinnamon oil leaf; (E)-3,7-dimethylocta-2,6-dienal; 3,7-dimethyloct-6-enal; 3,7-dimethyloct-6-en-1-ol; (E)-1-(2,6,6-trimethylcyclohexa-1,3-dien-1-yl)but-2-en-1-one; 6-pentyltetrahydro-2H-pyran-2-one; 5-hexyloxolan-2-one; decanal; chroman-2-one; methyl 2-(methylamino)benzoate; dimethyl sulfide; oxydibenzene; 1-methyl-4-prop-1-en-2-ylcyclohexene; 5-octyloxolan-2-one; ethyl acetate; ethyl butanoate; ethyl 2-methylpropionate; ethyl 3-phenylprop-2-enoate; ethyl decanoate; 6-ethyl-1,5,5-trimethylbicyclo[2.2.1]heptan-6-ol; ethyl formate; ethyl heptanoate; ethyl hexanoate; ethyl 3-hydroxybutanoate; ethyl 3-hydroxyhexanoate; ethyl 2-methylbutanoate; ethyl octanoate; ethyl 3-methylbutanoate; ethyl propionate; 4-ethylphenol; pent-1-en-3-one; 2-methyl-5-propan-2-ylcyclohexa-1,3-diene; 7,11-dimethyl-3-methylidenedodeca-1,6,10-triene; 2-ethyl-4-hydroxy-5-methylfuran-3-one; (E)-3,7-dimethylocta-2,6-dien-1-ol; (E)-3,7-dimethylocta-2,6-dien-1-yl acetate; grapefruit oil; hexanal; hexaoic acid; E-hex-2-enal; (Z)-hex-3-en-1-ol; (Z)-hex-3-en-1-yl acetate; (E)-4-(2,6,6-trimethyl-1-cyclohex-2-enyl)but-3-en-2-one; (E)-4-(2,6,6-trimethylcyclohex-1-en-1-yl)but-3-en-2-one; lemon oil; lemon oil terpeneless; lime oil; lime oil terpeneless; 3,7-dimethylocta-1,6-dien-3-ol; 3,7-dimethylocta-1,6-dien-3-yl acetate; 3-hydroxy-2-methyl-4H-pyran-4-one; madarin oil; 4-methyl-4-sulfanylpentan-2-one; 2-(4-methylcyclohex-3-en-1-yl)propane-2-thiol; mercapto-para-menthan-3-one; methyl acetate; methyl 2-aminobenzoate; 2-methyl-butanoic acid; methyl 3-phenylprop-2-enoate; methyl 3-oxo-2-pentylcyclopentaneacetate; 5-methylfuran-2-carbaldehyde; 7-methyl-3-methyleneocta-1,6-diene; (Z)-3,7-dimethylocta-2,6-dien-1-yl acetate; 5-pentyloxolan-2-one; nonanal; 4,4a-dimethyl-6-(prop-1-en-2-yl)-4,4a,5,6,7,8-hexahydronaphthalen-2(3H)-one; 5-butyloxolan-2-one; octanal; octanoic acid; orange cold pressed oil; orange essence oil; orange oil terpenes; orris concrete; osmanthus absolute; 2,3-pentanedione; 3-methylbutyl acetate; 3-methylbutyl 3-methylbutanoate; propyl acetate; rose oil; (2E,6E,9E)-2,6,10-trimethyldodeca-2,6,9,11-tetraenal; (2E,6E)-2,6-dimethyl-10-methylidenedodeca-2,6,11-trienal; tangerine cold pressed oil; tarragon oil; 4-methyl-1-propan-2-ylcyclohex-3-en-1-ol; 1-methyl-4-propan-2-ylcyclohexa-1,3-diene; 2-(4-methyl-1-cyclohex-3-enyl)propan-2-ol; 1-methyl-4-(propan-2-ylidene)cyclohex-1-ene; 2-(4-methylcyclohex-3-en-1-yl)propan-2-yl acetate; 4a,5-dimethyl-3-prop-1-en-2-yl-2,3,4,5,6,7-hexahydro-1H-naphthalene; 4-hydroxy-3-methoxybenzaldehyde; and mixture thereof.

7. A method of preparing a flavored beverage composition according to claim 1, comprising the steps of the sequential, separate or simultaneous admixture of at least one amino acid, at least one succinic compound, at least one flavor ingredient and any other components that together comprise the flavored beverage composition.

8. The method according to claim 7 comprising the steps of:
a) forming a flavor concentrate comprising at least one amino acid; at least one succinic compound; and at least one flavor ingredient; and
b) diluting said flavor concentrate in water to form a flavored beverage composition.

9. The method according to claim 8, wherein the flavor concentrate is in the form of an emulsion, a solution, or a powder.

10. A flavor concentrate comprising:
at least one amino acid; at least one succinic compound; at least one flavor ingredient; and
optionally at least one citrate compound together in a package ready for dilution with water.

11. A method of preparing a flavor concentrate according to claim 10 comprising the steps of preparing a first, concentrated, flavor oil-in-water emulsion; and diluting this concentrated flavor emulsion with an aqueous phase comprising the at least one amino acid and the at least one succinic compound in order to form a flavor emulsion.

12. A method of improving the organoleptic properties of a flavored beverage composition, in particular improved taste, aroma and/or mouthfeel, said method comprising the step of the sequential, simultaneous or separate incorporation into said flavored beverage of at least one amino acid, and at least one succinic compound.

13. The use of the flavored beverage composition according to claim 1 to improve the organoleptic properties of the composition, including taste, aroma, and/or mouthfeel.

14. The flavored beverage composition according to claim 1, wherein the composition comprises from about 0.001% to about 0.5% by weight of at least one amino acid.

15. The flavored beverage composition according to claim 1, wherein the composition comprises from about 0.001% to about 0.05% by weight of gamma amino butyric acid.

16. The flavored beverage composition according to claim 1, wherein the composition comprises from about 0.001% to about 0.15% by weight of at least one succinic compound.

17. The flavored beverage composition according to claim 1, wherein the composition comprises from about 0.0001% to about 0.04% by weight of at least one flavor ingredient.

18. The flavored beverage composition according to claim 1, wherein the composition is carbonated.

19. The flavored beverage composition according to claim 1, further comprising at least one emulsifier and at least one rheology modifier.

20. The flavored beverage composition according to claim 1, wherein the composition comprises less than 10 wt % sugar.
